(19) United States
(12) Patent Application Publication
(10) Pub. No.: US 2024/0104613 A1
(43) Pub. Date: Mar. 28, 2024

(54) COMPUTER GENERATED PRICING AND PROMOTIONS FOR PERSONALIZED SALE OF AN ITEM

(71) Applicant: International Business Machines Corporation, Armonk, NY (US)

(72) Inventors: Raghuveer Prasad Nagar, Kota (IN); Reji Jose, Bangalore (IN); Vivek Arya, Bangalore (IN); Archana Suri, Bangalore (IN)

(21) Appl. No.: 17/936,229

(22) Filed: Sep. 28, 2022

(51) Int. Cl. G06Q 30/02; G06Q 30/06

(52) U.S. Cl. CPC G06Q 30/0283; G06Q 30/0201; G06Q 30/0269; G06Q 30/0633

(57) ABSTRACT

Generation of pricing and promotions for personalized sale of an item includes receiving ordering data associated with an item from a user using an electronic shopping platform accessed via a user device. A failure of the user to complete a purchase order is determined using shopping cart activities of an ordering system. Based on a search pattern of the user received from the ordering system, a price of the item is identified as causing the determined failure of the user to complete the purchase order. Within a predefined time interval from the determined failure, a price range for the item is generated including a confidence score derived based on the search pattern of the user. Based on the confidence score of the generated price range exceeding a threshold, a final price recommendation for the item is generated and communicated to the user device.

### BACKGROUND

The present invention generally relates to the field of cognitive-based commerce solutions, and more particularly to an artificial intelligence (AI) based system for dynamically generating pricing and promotions recommendations for a product for sale to a consumer.

A wide variety of products and services are now offered for sale through numerous sales channels including websites, call centers, and virtual assistants. Customers or shoppers can find virtually any product or service that suits nearly all of their needs via such sales channels. To purchase an item (product or service), customers typically add the item to a shopping cart and complete a checkout process. Successfully ordered items contribute to cart-to-order conversion factor computation. However, in some instances, a customer can view an item and add the item to the shopping cart without completing a purchase. This is usually referred to as a failed conversion. This behavior results in loss of sales because a large percentage of consumer sales are based upon the impulse purchasing phenomenon, i.e., a consumer decides on the spur of the moment that they desire an item and makes the purchase immediately. Thus, it is very likely that if customers leave the current website the purchase impulse may pass before their return. Additionally, it is possible that customers make the purchase at the next available site that carries the item looking for a better price or product characteristics (e.g., a different color, different size, etc.).

### SUMMARY

Shortcomings of the prior art are overcome and additional advantages are provided through the provision of a computer-implemented method for communicating personalized pricing and promotions to a user. The method includes receiving, by one or more processors, ordering data associated with an item from a user using an electronic shopping platform accessed via a user device, determining, by the one or more processors, a failure of the user to complete a purchase order using shopping cart activities of an ordering system, based on a search pattern of the user received from the ordering system, determining, by the one or more processors, a price of the item causing the determined failure of the user to complete the purchase order, within a predefined time interval from the determined failure, generating, by the one or more processors, a price range for the item including a confidence score derived based on the search pattern of the user, and based on the confidence score of the generated price range exceeding a threshold, generating, by the one or more processors, a final price recommendation for the item and communicating the final price recommendation to the user device.

Another embodiment of the present disclosure provides a computer system for communicating personalized pricing and promotions to a user, based on the method described above.

Another embodiment of the present disclosure provides a computer program product for automatically generating personalized pricing and promotions based on failed conversions, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 depicts a computer system for automatically generating pricing and promotions for personalized sale of an item, according to an embodiment of the present disclosure; and

FIG. 3 depicts a flowchart illustrating the steps of a computer-implemented method for automatically generating pricing and promotions for personalized sale of an item, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As previously mentioned, a wide variety of products and services are now offered for sale through numerous sales channels including websites, call centers, and virtual assistants. Currently, customers or shoppers can find virtually any product or service that suits nearly all of their needs via such sales channels. Shoppers typically add items to a shopping cart and complete a checkout process. Successfully ordered items contribute to cart-to-order conversion factor computation. However, in some instances, shoppers only view the product (or service) or add the product to the shopping cart without completing a purchase (i.e., failed conversion). This behavior results in the loss of sales because a large percentage of consumer sales are based upon the impulse purchasing phenomenon, i.e., a consumer decides on the spur of the moment that they desire an item and makes the purchase immediately. Thus, it is very likely that if shoppers leave the current website the purchase impulse may pass before their return. Additionally, it is possible that shoppers make the purchase at the next available retailer site that carries the product looking for a better price or product characteristics (e.g., a different color, different size, etc.).

A common reason for a failed conversion is the price of the product or service of interest. For instance, a shopper adds an item to a shopping cart, and then considers that the price is too high and would be worth looking elsewhere for a better deal. Hence, the shopper does not complete the purchase and the sale is lost.

Accordingly, embodiments of the present disclosure provide an artificial intelligence-based method, system, and computer program product for detecting price being the reason for a failed conversion of an item in which a shopper was interested, deriving a comfortable price range within a time period from the detected failed conversion, and generating dynamic personalized pricing and promotions within the derived price range.

Therefore, the following described exemplary embodiments provide an artificial intelligence (AI)-based method, system, and computer program product to, among other things, automatically generate personalized pricing and promotions for an item for sale to a consumer. The generated pricing and promotions are based on a failed conversion of the consumer and may provide a final price for the item that is within a dynamically derived comfortable price range for one or more items in which the consumer (i.e., user, shopper, customer, etc.) was interested before failing to convert.

Thus, the present embodiments have the capacity to improve the technical field of cognitive-based commerce solutions by automatically identifying the price of an item causing or being the reason for the consumer or user not finalizing a purchase (i.e., failing to convert), validating the failed conversion of the user being caused by the item price, determining a comfortable price range for the item in which the user was interested, and dynamically generating a final price or promotion for the item that is likely to cause the customer to purchase the item. Accordingly, the proposed embodiments may prevent loss of sales by detecting price being the cause of a failed conversion and generating personalized price and promotions recommendations based on real-time information regarding user's preferences that may increase cart-to-order conversions. Additionally, the proposed embodiments may generate pricing and promotions to a group of users created based on a type of connection with the user (e.g., social media connection) and a common failed conversion due to item price that may strengthen seller confidence and increase item sales.

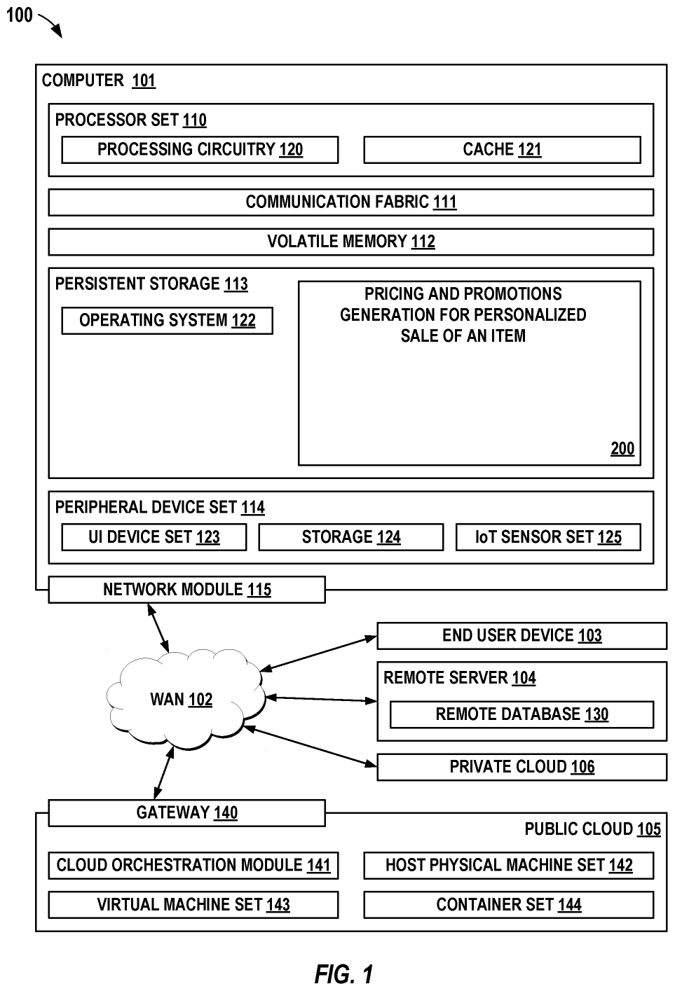

Referring now to FIG. 1, an exemplary computing environment 100 is depicted, according to an embodiment of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the pricing and promotions generation for personalized sale of an item code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

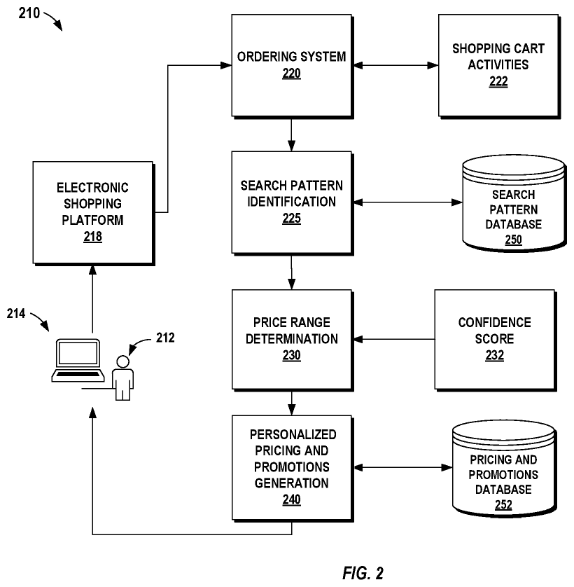

Referring now to FIG. 2, components of a computer system 210 for automatically generating pricing and promotions for personalized sale of an item are shown, according to an embodiment of the present disclosure.

In the depicted embodiment, a user 212 (i.e., consumer, customer, shopper, etc.) may access an electronic shopping platform 218 via, for example, a computer device 214. The computer device 214 may be, for example, a mobile device, a smartphone, a personal digital assistant, a netbook, a laptop computer, a tablet computer, a desktop computer, or any type of computing devices capable of accessing a network. As may be understood, the user 212 may perform a log-in process into the electronic shopping platform 218 which causes the electronic shopping platform 218 to recognize the user 212. User log-in can be based on any known authentication method including, for example, in-session log-in, default-user or last-logged-in user. In one or more embodiments, the user 212 may sign up for the proposed personalized pricing and promotions service provided by the computer system 210.

It should be noted that, in one or more embodiments, the computer system 210 may be part of an order management system, a sales channel (e.g., e-commerce website, call center, or store) or a pricing/promotion engine. In some embodiments, the computer system 210 may be an independent system.

Accordingly, the user 212 via the computer device 214 may access the electronic shopping platform 218 and browses for one or more items of interests. The one or more items of interests may include at least one of a product (e.g., a phone, TV, shoes, etc.) and a service (e.g., car insurance, cable TV, etc.). In one or more embodiments, the electronic shopping platform 218 communicates with an ordering system 220. The ordering system 220 collects ordering data associated with the one or more items of interest for the user 212. The ordering data collected by the ordering system 220 is based on shopping cart activities 222 of the ordering system 220 that are associated with, or has been performed by, the user 212.

In an embodiment, a search pattern identification module 225 receives from the ordering system 220 data associated with a search pattern of the user 212 and analyzes the search pattern to determine whether the user 212 is interested in buying one or more of the items of interest.

The interest or willingness of the user 212 to buy one or more of the items of interest can be derived based on, for example, user 212 adding one or more of the items to a shopping cart, or user 212 spending an amount of time t viewing the one or more items, with the amount of time t exceeding a predefined viewing threshold. In an exemplary embodiment, thresholds can be configured at item level, a category level, or a classification level. Default thresholds can also be configured in the search pattern identification module 225.

In some embodiments, search pattern identification module 225 may detect that the user 212 is currently viewing the one or more items on an item list page, a preview page, or details page. The search pattern identification module 225 may further determine a failed conversion of the user 212 (i.e., the user 212 does not purchase at least one of the one or more items in which the customer was initially interested). More particularly, using shopping cart activities 222 and the search pattern received from the ordering system 220, the search pattern identification module 225 determines a failure of the user to complete a purchase order of the one or more items.

According to an embodiment, the search pattern identification module 225 can identify the failed conversion of the user 212 based on activities performed by the user 212 during a session in the electronic shopping platform 218 including, for example, the user 212 removing one or more items from the shopping cart, or the user 212 not completing a purchase within a predefined time threshold (or purchasing time threshold). Such time threshold can also be configured at an item level, category level, or classification level. A default time threshold for purchasing the one or more items can also be configured or used. The search pattern identification module 225 may also identify the failed conversion of the item based on the user 212 cancelling a recently placed order via the ordering system 220.

Further, the search pattern identification module 225 may determine that the price of the one or more items may be the reason for the failed conversion of the user 212. According to an embodiment, such determination can be performed, for example, based on the search pattern performed by the user 212 in which words such as “price”, “cheaper” or a specific price range lower than a current price of the item of interest is included in the search criteria (e.g., user 212 searches for “smartwatches with a price less than $200”). It should be noted that the search can be performed on any integrated platform/system. For example, the failed conversion happened on a website, but the user 212 performs the price-based search on a mobile application.

In one or more embodiments, the search pattern identification module 225 may use IoT data across user devices such as smart phones, personal assistants, smart watches, and smart TVs to identify and verify a failed conversion of an item. For example, user 212 may ask a virtual assistant (e.g., Amazon Alexa, Google Home, etc.) to provide options for the item category with a price range lower than the price that was initially displayed for the item.

Additionally or alternatively, the search pattern identification module 225 may use available data from social media sites associated with the user 212 having price related information. For example, after viewing the one or more items, the user 212 makes a social media post saying that the price of one or more of the items is too high. More particularly, the search pattern identification module 225 may analyze social media data and search patterns to identify, for instance, whether the user 212 is looking for a lower price range. In an exemplary embodiment, social media data may be analyzed using NLP techniques; specifically, syntax and semantics techniques.

In yet another embodiment, the search pattern identification module 225 may use Customer Service Interaction data, generally available in systems such as call center management and CRM. Speech-to-text conversion along with NLP techniques may be used by the search pattern identification module 225 to identify voice interaction data associated with the user 212 and, for example, a customer service representative.

In some embodiments, user's eye movement during the failed session can be used by the search pattern identification module 225 to verify the failed conversion of the user 212 (e.g., user 212 looked at the price of the item before leaving the website). Specifically, when available, eye tracking technology incorporated in user's devices may be used to detect that the user 212 changed their mind regarding the one or more items after looking at the price.

Finally, search pattern identification module 225 may detect (using one or more of the data sources described above) that the user 212 visits a traditional street-side business (i.e., physical stores) offering products or services that are similar to the one or more items in which the user 212 was initially interested before failing to convert. In other embodiments, the search pattern identification module 225 may detect the user 212 searching for similar items on a different e-commerce site or store.

It should be noted that data collection (e.g., from IoT devices, social media sites, etc.) is done with user's consent via, for example, an opt-in and opt-out feature. The user can choose to stop having his/her information being collected or used. In some embodiments, the user can be notified each time data is being collected. The collected data is envisioned to be secured and not shared with anyone without previous consent. The user can stop data collection at any time.

The search pattern identification module 225 may store the identified search patterns and preferences of the user 212 in a search pattern database 250 that is communicatively connected to the search pattern identification module 225 for improving future pricing and promotions recommendations by the computer system 210.

After the search pattern identification module 225 verifies that the price of the one or more items is the reason for the user's failed conversion, the price range determination module 230 may derive a new price or price range for the one or more items in which the user 212 was initially interested. The new price or price range may be closer to identified price preferences of the user 212. According to an embodiment, the new price or price range may be derived based on one or more of the data types collected by the search pattern identification module 225 previously described including, for example, searches conducted by the user 212 (e.g., searches indicating a preferred price or price range), IoT data, social media data, a purchase history (showing a price range in which user 212 has bought similar items), Customer Service Interactions (e.g., after the failed conversion, user 212 asks a customer service representative to reduce the item price to $X), user profile and preferences (e.g., user 212 explicitly mentioning a price range).

In one or more embodiments, the derived price can be at least one of a price range (e.g., from $X to $Y), an exact price (e.g., $X), and a financing or spending plan (e.g., paying $X over a month, a year, etc.). According to a preferred embodiment, the new pricing for the one or more items can be derived based on a confidence score 232. The confidence score 232 may be assigned based on available user's data or activity. For instance, a price having a high confidence score 232 may be derived from a social media post in which the user 212 discloses a preferred price range between $100 and $110 for the one or more items, a price or price range having a medium confidence score 232 may be derived from a social media post in which the user 212 discloses a preferred price of “around” $100 for the one or more items, and a price or price range having a low confidence score 232 may be derived from a social media post in which the user 212 simply discloses that the price of the one or more items is too high. In an exemplary embodiment, a scale of the confidence score 232 can be configured having numerical (e.g., 1 to 10) or string (e.g., high, medium, and low) values.

According to an embodiment, the price range determination module 230 of computer system 210 may compare the initial price of the one or more items (i.e., price that caused the user 212 failing to convert) to the derived price or price range, and based on the computed confidence score 232 of the derive price or price range, an order is sent to the personalized pricing and promotions generation module 240 to generate pricing and promotions recommendations and communicate them to the user 212 via the computer device 214. In an embodiment, such pricing and promotion recommendations can be generated during the failed conversion session or after the failed conversion session. Preferably, the pricing and promotion recommendations are generated within a predefined time interval or recommendation threshold.

In addition to the derived price range, the personalized pricing and promotions generation module 240 may consider additional data while generating the pricing and/or promotions recommendations. Such additional data may include, for example, customer relevance, pricing and promotions offered by the competitors, purchase history (specially a purchase pattern of the user 212 during promotions), business targets (e.g., daily sales target), an integrated external system, and communications (e.g., emails from CEO, etc.).

In other embodiments, the personalized pricing and promotions generation module 240 may further generate the pricing and promotion recommendation based on an urgency with which the user 212 requires the one or more items. In an exemplary embodiment, the urgency can be derived using a calendar (e.g., user 212 has an event scheduled tomorrow for which the user 212 needs the one or more items), a purchase history (e.g., user 212 purchases the item every week, today is the 6th day from the last purchase date), an interaction with Customer Service Representatives (e.g., user 212 mentions that they need the item by the next day), a profile (e.g., according to the user profile, user 212 is a runner, the item of interest is a pair of running shoes and based on the user's calendar, there is a competition just 2 days away), and a purchase history or promotion for connections of the user 212 (e.g., social media connections).

In general, pricing recommendations can be generated based on a price change, user's connections, or user's region, while promotions can be generated based on item quantity, item combination/bundle and order total, and offering rewards on successful purchases (e.g., freebies, vouchers or coupons for future use).

In some embodiments, pricing and promotions can be assigned to a set of users (i.e., shoppers). For instance, the personalized pricing and promotions generation module 240 may assign pricing and promotions to one or more groups of users including the user 212 based on connections associated with the user 212. More particularly, the personalized pricing and promotions generation module 240 may dynamically create one or more groups of users based on a connection type with the user 212 (e.g., Facebook connections, LinkedIn connections, co-workers, etc.) that also experienced a conversion-failure due to price for the same item. In some embodiments, based on the connection type, the personalized pricing/promotions generation module 240 may generate different pricing or promotions for each different group of users.

In embodiments, in which one or more groups of users are created based on a connection type with the user 212, the personalized pricing and promotions generation module 240 may communicate or present the derived pricing and/or promotions to each user in the group of users. In one or more embodiments, communication involves simultaneously reporting two or more connections in the group of users of the derived pricing or promotion. For example, Adam and Tim are informed that a generated promotion includes both of them. It should be noted that creating the one or more of users based on the connection type with the user 212 (e.g., social media connections) may strengthen seller confidence and generate a positive influence by the user 212 on associated user connections, which may ultimately increase item sales.

In some embodiments, prior presenting the user 212 (or the one or more groups of users) with the generated recommendation, the personalized pricing and promotions generation module 240 may request approval of the newly generated pricing, price range or promotion by an approving entity (e.g., pricing manager). As depicted in the figure, the personalized pricing and promotions generation module 240 is communicatively connected to a pricing and promotions database 252 in which the derived pricing/promotions recommendations can be stored for future use by the computer system 210.

According to an embodiment, the computer system 210 is capable of improving future recommendations based on actions taken by the user 212 (or approving entity) on the generated recommendations (e.g., buying the item using the generated promotion, etc.). Such actions may also be stored by the computer system 210 to improve predicting capabilities.

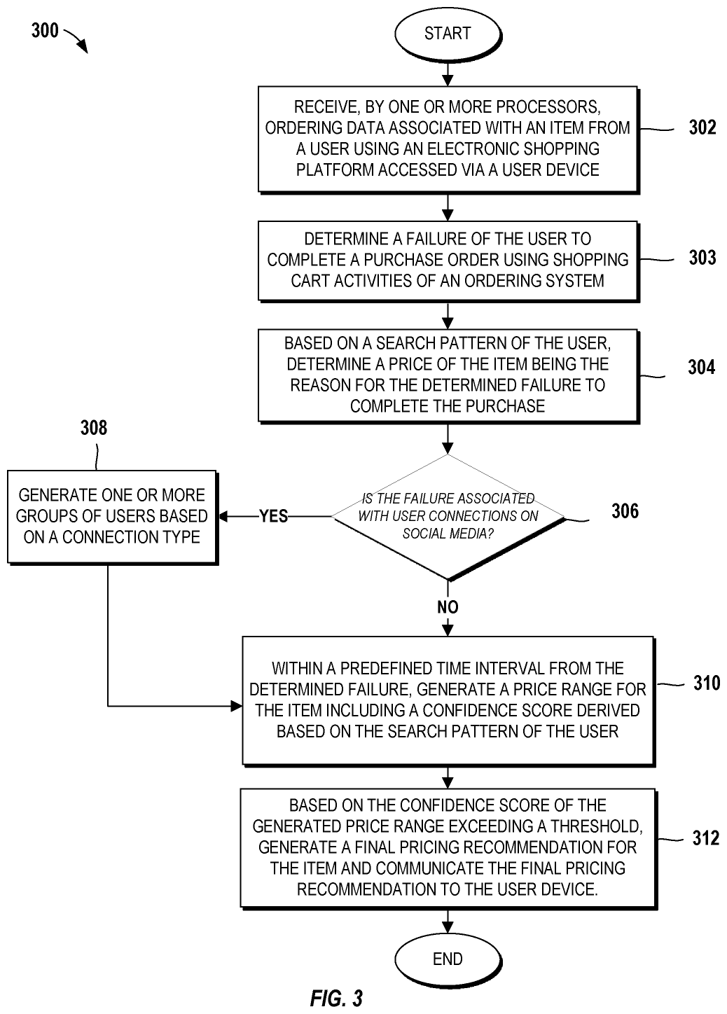

Referring now to FIG. 3, a flowchart 300 illustrating the steps of a computer-implemented method for automatically generating pricing and promotions for personalized sale of an item is shown, according to an embodiment of the present disclosure.

The process starts at step 302 in which a computer system, such as the computer system 210 described in FIG. 2, receives ordering data associated with an item from a user using an electronic shopping platform accessed via a user device. Then, at step 303, a failure of the user to complete a purchase order is determined using shopping cart activities of an ordering system. Stated differently, the method determines a failure to convert a user's (i.e., shopper, customer, etc.) interest in an item (e.g., product, service, etc.) into a purchase order using cart activities. In an embodiment, the cart activities conducted by the user and used to determine the failed conversion may include, for example, deleting an item from the cart, an incomplete item purchase within a time threshold, a cancellation of a recently placed order, and user messages including, but not limited to, an interaction with customer service, user's notes, instructions, publicly available posts of the user such as social media posts and blogs.

At step 304, based on a search pattern of the user, it is determined that a price of the item is the reason for the determined failure to complete the purchase. Stated differently, at step 304, the computer system 210 (FIG. 2) using collected data from the user determines that the failed conversion of the user is caused by the price of the item. The search pattern of the user may be determined based on actions performed by the user after the failed conversion including, but not limited to, a search criteria, subsequent IoT data, subsequent customer messages (e.g., interaction with customer service, notes, instructions, publicly available posts, etc.), eye movement during a search or failed session, subsequent searches, subsequent visits to physical stores and other user activities performed during the session of determined conversion failure.

The process continues at step 306 in which it is determined whether the item price being the reason for the failed conversation (i.e., the failure to purchase the item) is associated to one or more user connections. The one or more user connections may be social media connections of the user that also failed to convert due to the (same) item price. If the association between the one or more user connections and the determined conversion failure is verified at step 306, the process continues at step 308 in which groups of users including the user and user connections that also failed to convert due to item price are generated based on a connection type (e.g., Facebook connections, LinkedIn connections, co-workers, etc.). After generating the one or more groups of users based on the connection type at step 308, the process continues at step 310.

If the association between the one or more user connections and the determined conversion failure fails at step 306, the process continues at step 310.

At step 310, a price range is generated for the item including a confidence score within a predefined time interval from the determined conversion failure. The confidence score on the generate price range is based on the search pattern of the user. More particularly, the confidence score may be assigned based on actions performed by the user after the failed conversation. As explained above, in an exemplary situation, an item price having a high confidence score may be derived from a social media post in which the user specifically discloses a preferred price for the item (e.g., $100), an item price having a medium confidence score may be derived from a social media post in which the user discloses an interval of preferred prices for the item (e.g., a pair of shoes between $50 and $100, a watch less than $150, etc.), and an item price having a low confidence score may be derived from a social media post in which the user simply discloses that the price of the item is too high. In an exemplary embodiment, a scale of the confidence score can be configured having numerical (e.g., 1 to 10) or string (e.g., high, medium, and low) values. In one or more embodiments, the price range for the item is determined based on at least one of a recent search criteria, recent IoT data, recent user's messages, a reward point balance, recent item searches, and recent visits to traditional street-side stores.

Finally, at step 312, based on the confidence score of the generated price range exceeding a threshold, a final price recommendation is generated for the item. In embodiments in which the one or more groups of (social media) connections are generated, the recommendation on pricing or promotions are generated and communicated to each of the one or more groups of users via user devices. In one or more embodiments, the pricing and promotion recommendations can be generated based on an urgency of the user for the item or based on meeting a business sales target.

It should be noted that the proposed method may improve future pricing and promotions recommendations based on actions performed by the user in response to the generated final price recommendation including at least one of the user purchasing the item, the user using a generated promotion, and the generated final price being displayed to the user via a user device after receiving approval from a corresponding approval entity.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for communicating personalized pricing and promotions to a user using a device for shopping, comprising:
receiving, by one or more processors, ordering data from the user using an electronic shopping platform accessed via a user device, the ordering data being associated with an item;
determining, by the one or more processors, a failure of the user to complete a purchase order using shopping cart activities of an ordering system;
based on a search pattern of the user received from the ordering system, determining, by the one or more processors, a price of the item causing the determined failure of the user to complete the purchase order;
within a predefined time interval from the determined failure, generating, by the one or more processors, a price range for the item including a confidence score derived based on the search pattern of the user; and
based on the confidence score of the generated price range exceeding a threshold, generating, by the one or more processors, a final price recommendation for the item and communicating the final price recommendation to the user device.

2. The method of claim 1, further comprising:
dynamically generating, by the one or more processors, one or more user groups including the user and user's connections having a common failed conversion due to item price, wherein the one or more user groups are generated based on a type of connection including a social media connection; and
generating, by the one or more processors, recommendations on pricing and promotions for each of the one or more user groups and communicating the recommendations via user devices associated with each of the one or more user groups.

3. The method of claim 1, further comprising:
generating, by the one or more processors, recommendations on pricing and promotions by considering at least one of an urgency of the user for the item, and a business sales target.

4. The method of claim 1, further comprising:
improving, by the one or more processors, future pricing and promotions recommendations based on actions performed by the user in response to the generated final price recommendation including at least one of the user purchasing the item, the user using a generated promotion, and the generated final price being displayed to the user after receiving approval from a corresponding approval entity.

5. The method of claim 1, wherein determining the failure to convert is based on at least one of the user deleting the item from the shopping cart, an incomplete item purchase within a time threshold, a cancellation of a recently placed order, and activities performed by the user including interaction with customer service, notes, instructions, and publicly available posts such as social media posts and blogs.

6. The method of claim 1, wherein the search pattern of the user includes a search criteria after failing to convert, IoT data, user's messages including interaction with customer service, notes, instructions, publicly available posts, eye movement during a failed conversion session, searches after failing to convert, visits to traditional street-side stores and user activities during the failed conversion session.

7. The method of claim 1, wherein the price range for the item is determined based on at least one of a recent search criteria, recent IoT data, recent user's messages, a reward point balance, recent item searches, and recent visits to traditional street-side stores.

8. A computer system for communicating personalized pricing and promotions to a user using a device for shopping, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving, by the one or more processors, ordering data from the user using an electronic shopping platform accessed via a user device, the ordering data being associated with an item;
determining, by the one or more processors, a failure of the user to complete a purchase order using shopping cart activities of an ordering system;
based on a search pattern of the user received from the ordering system, determining, by the one or more processors, a price of the item causing the determined failure of the user to complete the purchase order;
within a predefined time interval from the determined failure, generating, by the one or more processors, a price range for the item including a confidence score derived based on the search pattern of the user; and
based on the confidence score of the generated price range exceeding a threshold, generating, by the one or more processors, a final price recommendation for the item and communicating the final price recommendation to the user device.

9. The computer system of claim 8, further comprising:
dynamically generating, by the one or more processors, one or more user groups including the user and user's connections having a common failed conversion due to item price, wherein the one or more user groups are generated based on a type of connection including a social media connection; and
generating, by the one or more processors, recommendations on pricing and promotions for each of the one or more user groups and communicating the recommendations via user devices associated with each of the one or more user groups.

10. The computer system of claim 8, further comprising:
generating, by the one or more processors, recommendations on pricing and promotions by considering at least one of an urgency of the user for the item, and a business sales target.

11. The computer system of claim 8, further comprising:
improving, by the one or more processors, future pricing and promotions recommendations based on actions performed by the user in response to the generated final price recommendation including at least one of the user purchasing the item, the user using a generated promotion, and the generated final price being displayed to the user after receiving approval from a corresponding approval entity.

12. The computer system of claim 8, wherein determining the failure to convert is based on the user deleting the item from the shopping cart, an incomplete item purchase within a time threshold, a cancellation of a recently placed order, and activities performed by the user including interaction with customer service, notes, instructions, and publicly available posts such as social media posts and blogs.

13. The computer system of claim 8, wherein the search pattern of the user includes a search criteria after failing to convert, IoT data, user's messages including interaction with customer service, notes, instructions, publicly available posts, eye movement during a failed conversion session, searches after failing to convert, visits to traditional street-side stores and user activities during the failed conversion session.

14. The computer system of claim 8, wherein the price range for the item is determined based on at least one of a recent search criteria, recent IoT data, recent user's messages, a reward point balance, recent item searches, and recent visits to traditional street-side stores.

15. A computer program product for communicating personalized pricing and promotions to a user using a device for shopping, comprising:
one or more computer readable storage media, and program instructions collectively stored on the one or more computer readable storage media, the program instructions comprising:
program instructions to receive, by one or more processors, ordering data from the user using an electronic shopping platform accessed via a user device, the ordering data being associated with an item;
program instructions to determine, by the one or more processors, a failure of the user to complete a purchase order using shopping cart activities of an ordering system;
based on a search pattern of the user received from the ordering system, program instructions to determine, by the one or more processors, a price of the item causing the determined failure of the user to complete the purchase order;
within a predefined time interval from the determined failure, program instructions to generate, by the one or more processors, a price range for the item including a confidence score derived based on the search pattern of the user; and
based on the confidence score of the generated price range exceeding a threshold, program instructions to generate, by the one or more processors, a final price recommendation for the item and communicating the final price recommendation to the user device.

16. The computer program product of claim 15, further comprising:
program instructions to dynamically generate, by the one or more processors, one or more user groups including the user and user's connections having a common failed conversion due to item price, wherein the one or more user groups are generated based on a type of connection including a social media connection; and
program instructions to generate, by the one or more processors, recommendations on pricing and promotions for each of the one or more user groups and program instructions to communicate the recommendations via user devices associated with each of the one or more user groups.

17. The computer program product of claim 15, further comprising:
program instructions to generate, by the one or more processors, recommendations on pricing and promotions by considering at least one of an urgency of the user for the item, and a business sales target.

18. The computer program product of claim 15, further comprising:
program instructions to improve, by the one or more processors, future pricing and promotions recommendations based on actions performed by the user in response to the generated final price recommendation including at least one of the user purchasing the item, the user using a generated promotion, and the generated final price being displayed to the user after receiving approval from a corresponding approval entity.

19. The computer program product of claim 15, wherein determining the failure to convert is based on the user deleting the item from the shopping cart, an incomplete item purchase within a time threshold, a cancellation of a recently placed order, and activities performed by the user including interaction with customer service, notes, instructions, and publicly available posts such as social media posts and blogs.

20. The computer program product of claim 15, wherein the search pattern of the user includes a search criteria after failing to convert, IoT data, user's messages including interaction with customer service, notes, instructions, publicly available posts, eye movement during a failed conversion session, searches after failing to convert, visits to traditional street-side stores and user activities during the failed conversion session, and wherein the price range for the item is determined based on at least one of a recent search criteria, recent IoT data, recent user's messages, a reward point balance, recent item searches, and recent visits to traditional street-side stores.
